(19) United States
(12) Patent Application Publication
(10) Pub. No.: US 2009/0234642 A1
(43) Pub. Date: Sep. 17, 2009

(54) Method and Apparatus for Low Complexity Combinatorial Coding of Signals

(75) Inventors: Udar Mittal, Hoffman Estates, IL (US); James P. Ashley, Naperville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/047,632

(22) Filed: Mar. 13, 2008

(51) Int. Cl. G10L 19/00

(52) U.S. Cl. 704/201; 704/E19.001

(57) ABSTRACT

To reduce the complexity of the encoding/decoding of pulse positions and/or pulse magnitudes associated with complex combinatorial computations, a method and structure for encoding and decoding of pulse position and/or pulse magnitudes requires fewer computations of these combinatorial functions. Approximation of such functions is acceptable as long as certain sufficient properties are maintained. Computational complexity of certain coding and decoding operations may be reduced by two orders of magnitude or more for a given signal vector input.

### BACKGROUND

Methods for coding vector or matrix quantities for speech, audio, image, video, and other signals are well known. One such method described in U.S. Pat. No. 6,236,960 by Peng, et. al, (which is incorporated by reference herein) is known as Factorial Pulse Coding (or FPC). FPC can code a vector xᵢ using a total of M bits, given that:

$$m = {\sum }_{i = 0}^{n - 1} \vert {x}_{i} \vert , \qquad ( 1 )$$

and all values of vector xᵢ are integral valued such that −m≦xᵢ≦m, where m is the total number of unit amplitude pulses, and n is the vector length. The total M bits are used to code N combinations in a maximally efficient manner, such that the following expression, which describes the theoretical minimum number of combinations, holds true:

$$N = {\sum }_{d = 1}^{min ( m , n )} F ( n , d ) D ( m , d ) {2}^{d} \leq {2}^{M} . \qquad ( 2 )$$

For this equation, F(n,d) are the number of combinations of d non-zero vector elements over n positions given by:

$$F ( n , d ) = \frac{n !}{d ! ( n - d ) !} , \qquad ( 3 )$$

D(m,d) are the number of combinations of d non-zero vector elements given m total unit pulses given by:

D(m,d)=F(m−1,d−1), (4)

and 2^{d} represents the combinations required to describe the polarity (sign) of the d non-zero vector elements. The term min(m, n) allows for the case where the number of unit magnitude pulses m exceeds the vector length n. A method and apparatus for coding and decoding vectors of this form have been fully described in the prior art. Furthermore, a practical implementation of this coding method has been described in 3GPP2 standard C.S0014-B, where the vector length n=54 and the number of unit magnitude pulses m=7 produce an M=35 bit codeword. While these values of n and m do not cause any unreasonable complexity burden, larger values can quickly cause problems, especially in mobile handheld devices which need to keep memory and computational complexity as low as possible. For example, use of this coding method for some applications (such as audio coding) may require n=144 and m=28, or higher. Under these circumstances, the cost associated with producing the combinatorial expression F(n,d) using prior art methods may be too high for practical implementation.
In looking at this cost in greater detail, we can rewrite Eq. 3 as:

$$F ( n , d ) = \frac{{\prod }_{i = n - d + 1}^{n} ( i )}{{\prod }_{j = 1}^{d} ( j )} . \qquad ( 5 )$$

Direct implementation is problematic because F(144, 28) would require 197 bits of precision in the numerator and 98 bits of precision in the nominator to produce a 99 bit quotient. Since most digital signal processors (DSPs) used in today's handheld devices typically support only 16 bit×16 bit multiply operations, special multi-precision multiply/divide routines would need to be employed. Such routines require a series of nested multiply/accumulate operations that typically require on the order of k multiple/accumulate (MAC) operations, where k is the number of 16 bit segments in the operand. For a 197 bit operand, k=┌197/16┐=13. So, execution of a single 197×16 bit multiply would require a minimum of 13 MAC operations plus shifting and store operations. The denominator term is calculated in a similar manner to produce a 98 bit result. In addition, a 197/98 bit division is required, which is an extremely complex operation, thus computation of the entire factorial relation in Eq. 5 would require considerable resources.
In an effort to reduce complexity, Eq. 5 can be rewritten to distribute the divide operations to produce the following:

$$F ( n , d ) = round [ ( \frac{n}{d} ) \cdot ( \frac{n - 1}{d - 1} ) \cdot ( \frac{n - 2}{d - 2} ) … ( \frac{n - d + 2}{2} ) \cdot ( \frac{n - d + 1}{1} ) ] \qquad ( 6 )$$

In this expression, the dynamic range of the divide operations is reduced, but unfortunately, increased resolution of the quotient is needed to accurately represent division by 3, 7, 9, etc. In order to accommodate this structure, a rounding operation is also needed to guarantee an integer result. Given the large number of high precision divide operations, this implementation does not adequately address the complexity problem for large m and n, and further has the potential to produce an incorrect result due to accumulated errors in precision.

In yet another implementation, Eq. 5 can be rearranged in the following manner:

$$F ( n , d ) = n \cdot ( n - 1 ) \cdot ( \frac{1}{2} ) \cdot ( n - 2 ) \cdot ( \frac{1}{3} ) … ( n - d + 2 ) \cdot ( \frac{1}{d - 1} ) \cdot ( n - d + 1 ) \cdot ( \frac{1}{d} ) . \qquad ( 7 )$$

If this expression is evaluated from left to right, the result will always produce an integer value. While this method controls the precision and dynamic range issue to some degree, large values of m and n still require extensive use of multi-precision multiply and divide operations.

Finally, in order to minimize computational complexity, it may be possible to pre-compute and store all factorial combinations in a lookup table. Thus, all values of F(n,m) may be simply stored in an n×m matrix and appropriately retrieved from memory using very few processor cycles. The problem with this approach, however, is that as n and m become large, so does the associated memory requirement. Citing the previous example, F(144, 28) would require 144×28×┌99 bits/8 bits/byte┐=52,416 bytes of storage, which is unreasonable for most mobile handheld devices. Therefore, a need exists for a method and apparatus for low-complexity combinational Factorial Pulse Coding of vectors.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram of an encoder.

FIG. 2 is a block diagram of a decoder.

FIG. 3 is a flow chart showing operation of a combinatorial function generator of FIG. 1 and FIG. 3.

FIG. 4 is a flow chart showing operation of the encoder in accordance with various embodiments.

FIG. 5 is a flow chart showing operation of the decoder in accordance with various embodiments.

FIG. 6 is a flow chart showing operation for combinatorial encoding or decoding in accordance with various embodiments.

FIG. 7 is a flow chart showing operation for decoding a vector from a codeword in accordance with various embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The present invention relates generally to coding vectors and in particular, to combinational Factorial Pulse Coding of vectors. In order to address certain deficiencies known in the art, a method and apparatus for low-complexity combinatorial coding of vectors is provided herein. During operation an encoder and decoder will use relatively low resolution approximations of factorial combinations F′(n, d), which provide only enough precision to allow a valid codeword to be generated. Particularly, both an encoder and a decoder will utilize a combinatorial function generator to derive F′(n, d) such that F′(n,d)≧F(n,d), and F′(n,d)≧F′(n−1,d)+F′(n−1,d−1). F′(n, d) will be provided to either coding or decoding circuitry to produce a combinatorial codeword or vector xᵢ, respectively.

Because F′(n, d) will have a lower precision than F(n, d), it is generally much easier to compute on a fixed point digital signal processor (DSP), general purpose microprocessor, or implement in hardware, such as on a programmable logic device or application specific integrated circuit (ASIC). In essence, complicated multi-precision multiplications and divisions are replaced with relatively low precision additions and subtractions, coupled with a small amount of table memory. Generally, the lower complexity operations do not affect the overall coding rate of the input vectors, but it may be possible to lower the complexity even further than is described herein at the expense of a slightly higher bit-rate.

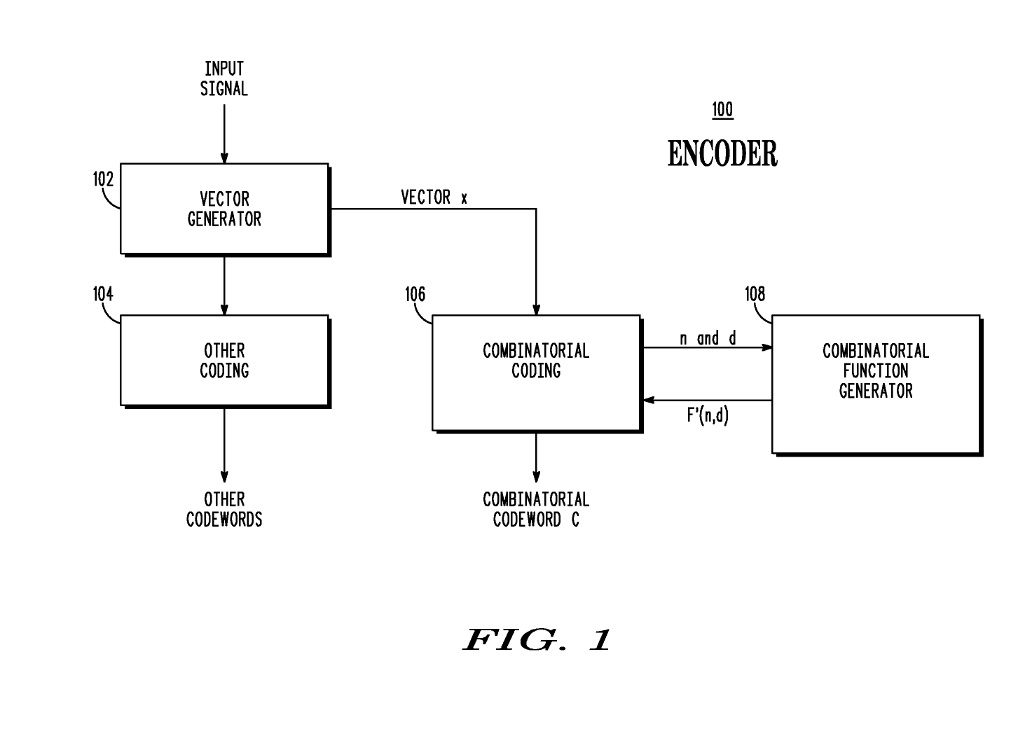

Turning now to the drawings, wherein like numerals designate like components, FIG. 1 is a block diagram of encoder 100. Encoder 100 comprises vector generator 102, combinational coding circuitry (coder) 106, combination function generator 108, and other coding circuitry 104. During operation, an input signal to be coded is received by vector generator 102. As is known in the art, the input signal may comprise such signals as speech, audio, image, video, and other signals.

Vector generator 102 receives the input signal and creates vector xᵢ. Vector generator 102 may comprise any number of encoding paradigms including, but not limited to, Code-Excited Linear Prediction (CELP) speech coding as described by Peng, et. al, transform domain coding for audio, images and video including Discrete Fourier Transform (DFT), Discrete Cosine Transform (DCT), and Modified Discrete Cosine Transform (MDCT) based methods, wavelet based transform coding, direct time domain pulse code modulation (PCM), differential PCM, adaptive differential PCM (ADPCM), or any one of a family of sub-band coding techniques that are well known in the art. Virtually any signal vector of the form given above may be advantageously processed in accordance with the present invention.

Combinatorial coding circuitry 106 receives vector xᵢ and uses Factorial Pulse Coding to produce a codeword C. As discussed above Factorial Pulse Coding can code a vector xᵢ using a total of M bits, given that

$$m = {\sum }_{i = 0}^{n - 1} \vert {x}_{i} \vert ,$$

and all values of vector xᵢ are integral valued such that −m≦xᵢ≦m, where m is the total number of unit amplitude pulses, and n is the vector length. As discussed above, larger values of m and n can quickly cause problems, especially in mobile handheld devices which need to keep memory and computational complexity as low as possible.

In order to address this issue, combinatorial function generator 108 utilizes a low complexity technique for producing F′(n,d). Combinatorial coding circuitry 106 then utilizes F′(n,d) to produce codeword C. Circuitry 108 utilizes relatively low resolution approximations (bits of precision) of factorial combinations F′(n, d), which provide only enough precision to allow a valid codeword to be generated. That is, as long as certain properties are maintained, a suitable approximation of the function F(n, d) is sufficient to guarantee that the resulting codeword is uniquely decodable.

In order to describe the generation of F′(n,d), let us proceed by first deriving a function F′(n,d) that is a suitable approximation of F(n, d). First is to take the logarithm of an arbitrary base a of Eq. 5, and taking the inverse log base a of the rearranged terms:

$$F ( n , d ) = {exp}_{a} ( {\sum }_{i = n - d + 1}^{n} {log}_{a} ( i ) - {\sum }_{j = 1}^{d} {log}_{a} ( j ) ) , \qquad ( 8 )$$

where the function expₐ(k)=a^{k}. Next, define functions P(i), Q(d), and R(k), and substitute into Eq. 8 such that:

$$F ( n , d ) = R ( {\sum }_{i = n - d + 1}^{n} P ( i ) - Q ( d ) ) , \\ where P ( i ) = {log}_{a} ( i ) , \\ Q ( d ) = {\sum }_{j = 1}^{d} {log}_{a} ( j ) , \\ and \\ R ( k ) = {exp}_{a} ( k ) = {a}^{k} . \qquad ( 9 )$$

However, in accordance with the preferred embodiment of the present invention, it is not necessary for F(n, d) and F′(n, d) to be equivalent in order for the resulting codeword to be uniquely decodable. There are only two conditions that are sufficient for this to hold true:

F′(n,d)≧F(n,d), (10)

and

F′(n,d)≧F′(n−1,d)+F′(n−1,d−1). (11)

For the first condition, the restriction simply says that if F′(n, d)<F(n, d), then there will be overlapping code-spaces, and subsequently, there will be more than one input capable of generating a particular codeword; thus, the codeword is not uniquely decodable. The second condition states that the “error” for a given n, d shall be greater than or equal to the sum of the error terms associated with the previous element of the recursive relationship described by Peng, et. al in U.S. Pat. No. 6,236,960. It can be shown that F(n, d)=F(n−1, d)+F(n−1, d−1), which is only true if the combinatorial expression is exactly equal to F(n,d)=C_{d}ⁿ=n!/d!(n−d)!. However, while the inequality in Eq. 11 is sufficient, it may not necessarily be true for all values of n and d. For such values, F(n,d) may satisfy another inequality derived from Eq. 31 of Peng, et al. and is given by:

$$F ( n , d ) > {\sum }_{i = 1}^{d} F ( n - ( d - i + 1 ) , i ) . \qquad ( 12 )$$

In this case, Eq. 11 has to be satisfied with strict inequality for certain (m,k), (m≦n), (k≦d), that is:

F(m,k)>F(m−1,k)+F(m−1,k−1),m≦n,k≦d. (13)

Referring back to Eq. 9, we now wish to generate F′(n, d) by creating the functions P′(i), Q′(d), and R′(k), with low complexity approximations of the original functions such that:

$${F}^{′} ( n , d ) = {R}^{′} ( {\sum }_{i = n - d + 1}^{n} {P}^{′} ( i ) - {Q}^{′} ( d ) ) , \qquad ( 14 )$$

and where the conditions given in Eqs. 10 and 11 are satisfied. Considering P(i), we may wish to approximate the function such that P′(i)≧logₐ(i), iε[1, 2, . . . , n]. If we choose a=2 and then restrict P′(i) to 32 bits of precision, the resulting operations are easy to implement on a handheld mobile device since most DSPs support single cycle 32 bit additions. Therefore, we define:

P′(i)=2^{-l(i)}└2^{l(i)}log₂(i)+1┘,iε[1,2, . . . , n], (15)

where l(i) is a shift factor that may vary as a function of i. In the preferred embodiment, l(i)=l=21, but many other sets of values are possible. For this example, the 2^{l} factor is equivalent to a shift of l bits to the left, whereby the floor function └x+1┘ removes the fractional bits while rounding up to the next highest integer, and finally the 2^{-l} factor shifts the results back to the right by l bits. Using this methodology, the function P′(i)≧log₂(i) for all i≧1, and also provides sufficient dynamic range and precision using only 32 bits because 9 bits of positive integer resolution in the log₂ domain can represent a 512 bit number. To avoid the complexity of computing these values in real-time, they can be pre-computed and stored in a table using only 144×4 bytes of memory for the F(144, 28) example. Using a similar methodology for approximating Q(d), we get:

$${Q}^{′} ( d ) = \{ \begin{matrix}0 , & d = 1 \\ {\sum }_{j = 2}^{d} {2}^{- l ( j )} ⌊ {2}^{l ( j )} {log}_{2} ( j ) - 1 ⌋ , & d ∈ [ 2 , … , m ] ,\end{matrix} \qquad ( 16 )$$

where the floor function └x−1┘ is used because of the subtraction of the quantity from the total. This guarantees that

$${Q}^{′} ( d ) \leq {\sum }_{j = 1}^{d} {log}_{2} ( j )$$

so that the contribution of Q′(d) will guarantee F′(n,d)≧F(n,d). While l(j) can assume many values depending on the configuration of m and n, the preferred embodiment uses a values of l(j)=l=14 for the variable shift factor. Like P′(i), Q′(d) can be pre-computed and stored in a table using only 28×4 bytes of memory for the F(144, 28) example. For defining R′(k), we need to first define k as:

$$k = {\sum }_{i = n - d + 1}^{n} {P}^{′} ( i ) - {Q}^{′} ( d ) . \qquad ( 17 )$$

With P′(i) and Q′(d) defined above, k is preferably a 32 bit number with an 8 bit unsigned integer component kᵢ and a 24 bit fractional component k_{f}. Using this, we may derive R′(k)≧exp₂(k)=2^{k} by letting k=kᵢ+k_{f} and then taking the inverse logarithm base 2 to yield 2^{k}=2^{k}^{ᵢ}2^{k}^{_{f}}. We may then use a Taylor series expansion to estimate the fractional component to the desired precision, represented by K_{f}=2^{k}^{_{f}}, rounding up the result using the ceiling function, and then appropriately shifting the result to form a multi-precision result (with only l significant bits), such that:

R′(k)=2^{k}^{ᵢ}⁻¹┌2^{l}K_{f}┐, (18)

where 2^{k}^{ᵢ} is the integer shift factor applied to the Taylor series expansion result. Here, l is a shift factor used in a similar manner to Eqs. 15 and 16 to guarantee R′(k)≧2^{k}. However, since R′(k) cannot be practically pre-computed for efficient real-time operation, great care must be taken in specifying the exact operations necessary in both the encoder and decoder to ensure that the reconstructed signal vector matches the input signal vector exactly. Note that R′(k) may be obtained from left shifting ┌2^{l}K_{f}┐, which can be accurately represented by l bits.

In the above discussion, functions P′(i), Q′(d), and R′(k) have been chosen such that each individual function estimate guarantees that the resulting F′(n,d)≧F(n,d). However, it is only necessary for the aggregate effect to satisfy this condition. For example, P′(i) and Q′(d) may be as described above, but R′(k) may be a more conventional R′(k)≈2^{k} function which may truncate or round the least significant bits such that R′(k) may be less than 2^{k} for some values of k. This is acceptable as long as this effect is small relative to the effects of P′(i) and Q′(d), so the properties in Eqs. 10 and 11 still hold true.

Also, any functions P′(i), Q′(d), and R′(k) may be used without loss of generality as long as the properties on Eqs. 10 and 11 are satisfied. Care must be taken however, that an increase in bit rate may occur if too little precision is used. It should also be noted that there is an inherent tradeoff in bit rate and complexity, and for large values of m, n, an increase of 1 or 2 bits may be a reasonable tradeoff for a significant reduction in complexity.

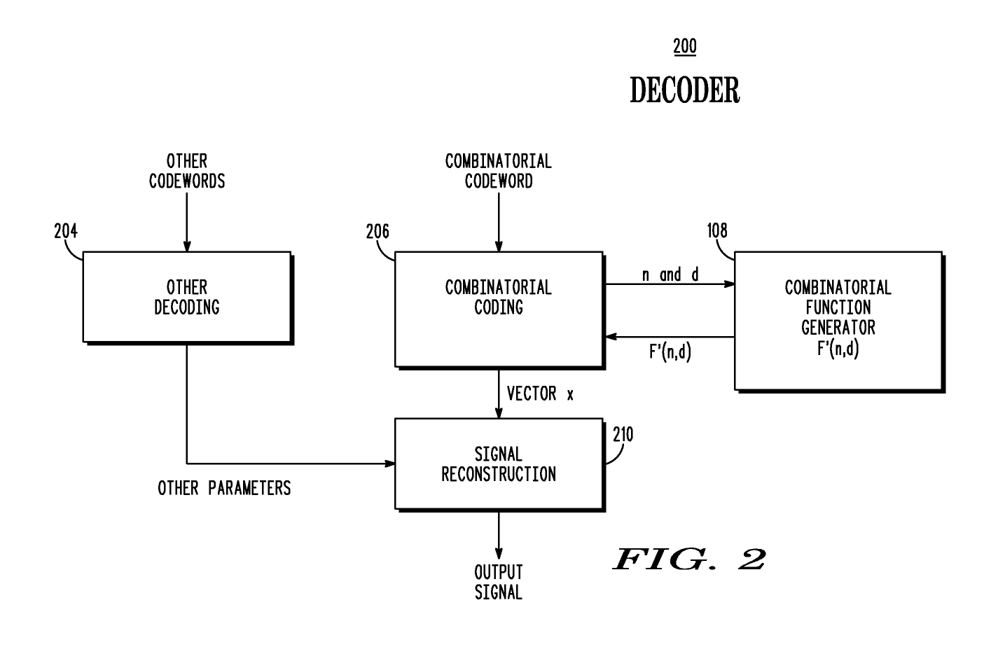

Referring again to the drawings, FIG. 2 is a block diagram of decoder 200. As shown, decoder 200 comprises combinatorial decoding circuitry (decoder) 206, signal reconstruction circuitry 210, other decoding circuitry 204, and combinatorial function generator 108. During operation a combinatorial codeword is received by combinatorial decoding circuitry 206. Combinatorial decoding circuitry 206 provides n and d to combinatorial function generator, and receives F′(n,d) in response. Decoding circuitry 206 then creates vector xᵢ based on F′(n, d). Vector xᵢ is passed to signal reconstruction circuitry 210 where the output signal (e.g., speech, audio, image, video, or other signals) is created based on xᵢ and other parameters from other decoding circuitry 204. More specifically, the other parameters may include any number of signal reconstruction parameters associated with the signal coding paradigm being used in a particular embodiment. These may include, but are not limited to, signal scaling and energy parameters, and spectral shaping and/or synthesis filter parameters. Normally these parameters are used to scale the energy of and/or spectrally shape the reconstructed signal vector xᵢ in such a manner as to reproduce the final output signal.

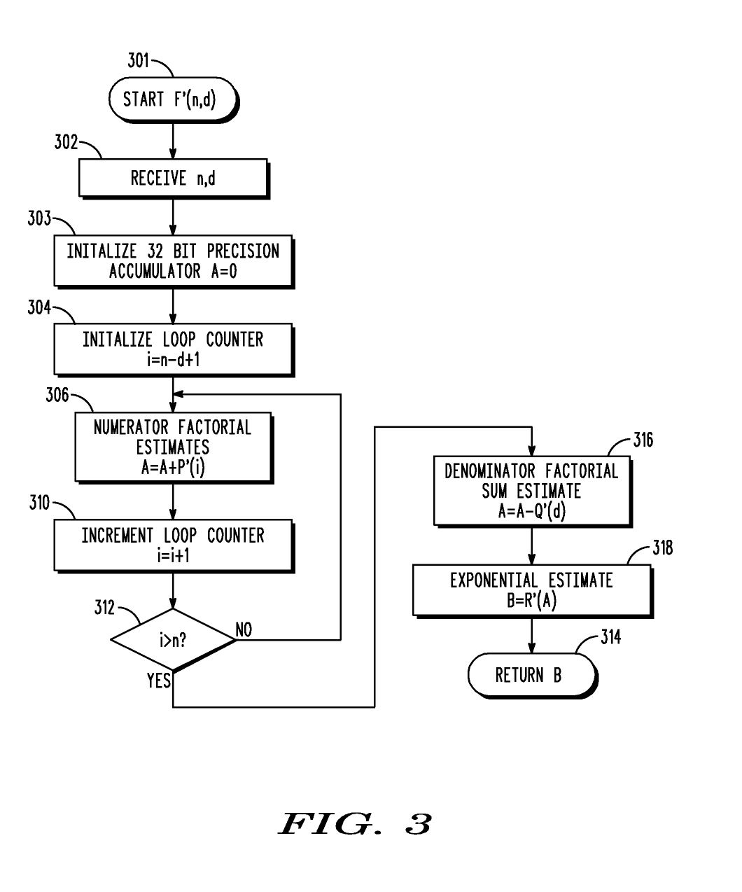

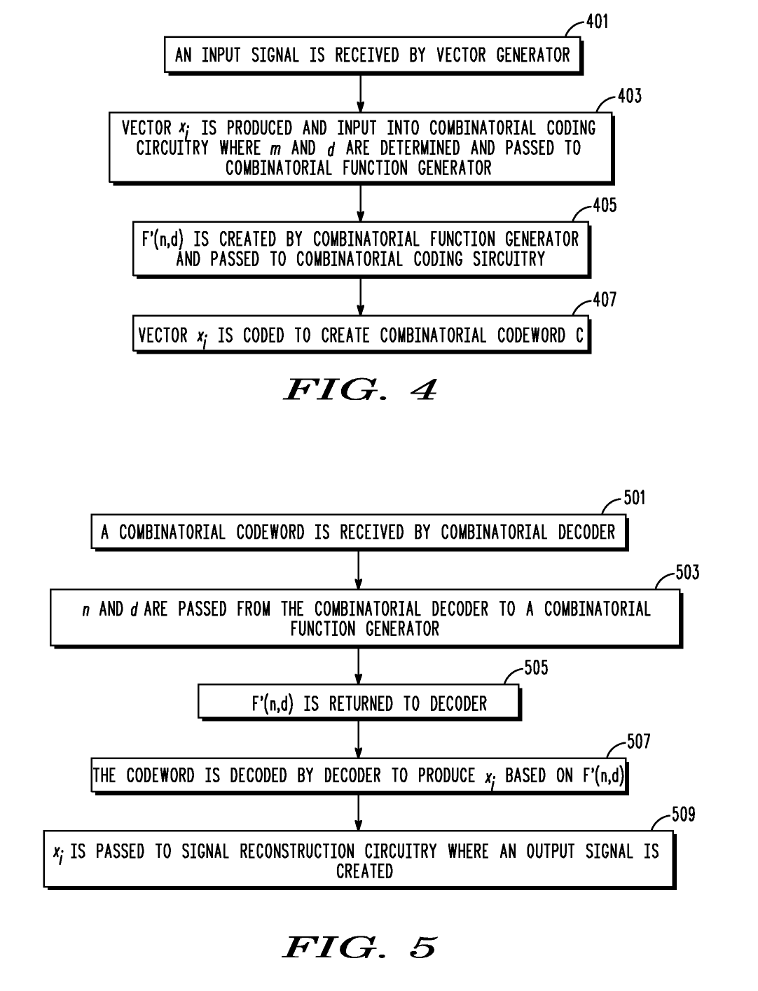

FIG. 3 is a flow chart showing operation of a combinatorial function generator of FIG. 1 and FIG. 2. More particularly, the logic flow of FIG. 4 shows the flow for combinatorial function generator 108 to produce F′(n,d). The logic flow begins at 302 where the inputs n and d are received. At 303 accumulator A is set to 0. At 304 the counter i is set equal to n−d+1. At 306 logarithm approximation P′(i) is added to the accumulator A. At 310 counter i is incremented by 1. 306 and 310 are repeated in a loop until the counter i is greater than n. 312 tests i>n and terminates the loop when i becomes greater than n. At this stage the accumulator contains the logarithm approximate of the numerator of the combinatorial function F(n, d). A logarithm approximation of the denominator of the combinatorial function Q′(d) is subtracted from the accumulator at 316 to obtain a logarithm approximation of the combinatorial function. At 318 an exponential approximation R′(A) of the accumulator is taken to generate the approximation B of the combinatorial function. At 314, B is outputted as F′(n, d). FIG. 4 is a flow chart showing operation of the encoder of FIG. 1. The logic flow begins at 401 where an input signal is received by vector generator 102. As discussed above, the input signal may comprise speech, audio, image, video, or other signals. At 403 vector xᵢ is produced and input into combinatorial coding circuitry 106 where m and d are determined and passed to combinatorial function generator 108. As discussed above, m is the total number of unit amplitude pulses (or sum of the absolute values of the integral valued components of xᵢ) and d is the number non-zero vector elements of xᵢ. At 405 F′(n, d) is created by combinatorial function generator 108 and passed to combinatorial coding circuitry 106, where vector xᵢ is coded to create combinatorial codeword C (407). As discussed above, F′(n, d) is created by replacing the functions P(i), Q(d), and R(k) in F(n, d), with low complexity approximations of the original functions such that the conditions given in Equations 10 and 11 are satisfied.

FIG. 5 is a flow chart showing operation of the decoder of FIG. 2. The logic flow begins at 501 where a combinatorial codeword is received by combinatorial decoder 206. At 503 n and d are passed from combinatorial decoder 206 to combinatorial function generator 108 and F′(n, d) is returned to decoder 206 (505). The codeword is decoded by decoder 206 based on F′(n, d) (507) to produce vector xᵢ and xᵢ is passed to signal reconstruction circuitry 210 where an output signal is created (509).

The formulation of the partial codeword C, for position and magnitudes, in combinatorial coding circuitry 106 is now described. Let π={p₁, p₂, . . . , pᵥ} be the non-zero pulse positions (in increasing order) and μ={m₁, m₂, . . . , mᵥ} be the magnitudes at respective positions within a vector x. The code for pulse positions is given by:

$${C}_{π} = {\sum }_{k = 1}^{v} F ( {p}_{k} , k ) 0 \leq {p}_{k} < n , \qquad ( 19 )$$

and the code for pulse magnitudes is given by:

$${C}_{μ} = {\sum }_{k = 1}^{v - 1} F ( {\sum }_{j = 1}^{k} {m}_{j} - 1 , k ) 1 \leq {\sum }_{j = 1}^{k} {m}_{j} , {m}_{k} < m . \qquad ( 20 )$$

Thus, the formulation of these codeword requires addition of v and v−1 multi-precision numbers. Similar subtraction operations are needed in the decoder.

As mentioned before, the combinatorial function is replaced by an approximate function F′(n,r) which is given as:

$$\begin{matrix}{F}^{′} ( n , r ) = {R}^{′} ( {\sum }_{i = n - r + 1}^{n} {P}^{′} ( i ) - {Q}^{′} ( r ) ) , & ( 21 ) \\ where & \\ {Q}^{′} ( r ) - \{ \begin{matrix}0 , & r = 1 \\ {\sum }_{j = 2}^{r} {2}^{- {l}_{Q}} ⌊ {2}^{{l}_{Q}} {log}_{2} ( j ) - 1 ⌋ , & r > 1 ,\end{matrix} & ( 22 )\end{matrix}$$

and R′(k) is an approximation of the function R′(k)≈2^{k}, given as:

R′(k)=└2^{k}^{ᵢ}^{-l}^{_{R}}└2^{l}^{_{R}}K_{f}┘┘, (23)

where k=kᵢ+k_{f} is broken down into integer and fractional components of k, and K_{f}=2^{k}^{_{f}} is a low resolution Taylor series expansion of the fractional component of k. Based on the above pre-defined functions Q′(r) and R′(k), P′(i) are first obtained so that the unique decodability inequality

F′(n,d)>F′(n−1,d)+F′(n−1,d−1) (24)

is satisfied for all values of n and d.

Going back to equations (19) and (20), replacing approximate functions F′ in place of actual functions F yields:

$$\begin{matrix}{C}_{π} = {\sum }_{k = 1}^{v} {F}^{′} ( {p}_{k} , k ) 0 \leq {p}_{k} < n , & ( 25 ) \\ {C}_{μ} = {\sum }_{k = 1}^{v - 1} {F}^{′} ( {\sum }_{j = 1}^{k} {m}_{j} - 1 , k ) 1 \leq {\sum }_{j = 1}^{k} {m}_{j} , {m}_{k} < m . & ( 26 )\end{matrix}$$

To further reduce the complexity of the approximate combinatorial function in (21), instead of pre-storing P′(i) a partial summation of P′(i) such as:

$${S}^{′} ( n ) = {\sum }_{i = 1}^{n} {P}^{′} ( i ) , \qquad ( 27 )$$

and now equation (21) can be equivalently computed as:

F′(n,d)=R′(S′(n)−S′(n−d)−Q′(d)) (28)

Even though using the approximate combinatorial functions has reduced the complexity significantly, the computation of these functions still forms one of the major parts of the complexity of the coding. Even with these improvements, the decoder has a significant complexity. This is because the decoder needs to repeatedly find the largest value of pₖ such that F′(pₖ, k) is less than a multi-precision number Cₖ. The decoder iteratively obtains such a value of pₖ. These iterations may require several computations of the combinatorial functions which add to the complexity of the decoding process.

Hence, there is a need for a coding method where the decoder does not need to iterate to obtain pₖ. If equation (28) is used for defining F′(pₖ, k) then it may not be feasible to obtain such a solution without iterations.

We redefine the approximate combinatorial function as:

$${F}^{′} ( n , d ) = \{ \begin{matrix}{R}^{′} ( d \cdot {P}^{′} ( 2 \cdot n - d + 1 ) - d - {Q}^{′} ( d ) ) & n \geq 2 \cdot d \\ F ( n , n - d ) & Otherwise\end{matrix} \\ where \\ {P}^{′} ( i ) = {2}^{- l ( i )} ⌊ {2}^{l ( i )} {log}_{2} ( i ) + 1 ⌋ , i ∈ [ 1 , 2 , … , n ] \qquad ( 29 )$$

is the logarithm of i, up to l(i)=16 decimal places, and Q″(d)=Q′(d)+d is pre-calculated and stored such that F′(n, d) defined in (29) satisfies the unique decodability inequality (24).

With Q′(d) defined in (16) as the approximate logarithm (base 2) of d!, the F′(n, d) defined in (29) is an approximation of actual combinatorial function defined in equation (3) and equation (5). Going back to equation (5), the numerator can be said to be the d^{th} power of the geometric mean of: n, n−1, n−2, . . . , n−d+1. The arithmetic mean of these numbers is

$$n - \frac{d - 1}{2} .$$

If we approximate the geometric mean with an arithmetic mean the approximation of equation (5) can be written as:

$${F}^{′} ( n , d ) \approx \frac{{( n - \frac{d - 1}{2} )}^{d}}{{\prod }_{j = 1}^{d} ( j )} \qquad ( 30 )$$

If we take the logarithm (base 2) of equation (29) and used an approach similar to the one used in getting equation (21), we get

$$\begin{matrix}{F}^{′} ( n , d ) = {R}^{′} ( d \cdot {log}_{2} ( 2 \cdot n - d + 1 ) - d - {\sum }_{i = 1}^{d} {log}_{2} ( i ) ) \\ Thus & ( 31 ) \\ {F}^{′} ( n , d ) = {R}^{′} ( d \cdot {P}^{′} ( 2 \cdot n - d + 1 ) - d - {Q}^{′} ( d ) ) . & ( 32 )\end{matrix}$$

where

$${P}^{′} ( n ) \approx {log}_{2} ( n ) , {Q}^{′} ( d ) \approx {\sum }_{i = 1}^{d} {log}_{2} ( i ) , R ( k ) \approx {2}^{k} .$$

A low complexity Taylor series is used for generating R′(k). The method for generating R′(k) is described in the discussion following equation (18).
Equation (32) can be rewritten as

F′(n,d)=R′(k), (32a)

where

k=d·P′(2·n−d+1)−d−Q′(d). (32b)

In order to decrease the complexity of computing F′(n, d) in equation (32), it is desired that equation (32b) should have low complexity. This can be achieved by storing P′(n) and Q′(d) in a computer memory. The proper value now can be fetched whenever needed. In one of the embodiments, the suitably scaled or shifted value of P′(n) and Q′(d) are stored in memory. In another embodiment, a part of P′(n), and a suitable modification Q′(d)+d are stored so that k(n, d) can be computed from the stored components. It can be easily seen that

$$\begin{matrix}k = d \cdot {P}^{′} ( 2 \cdot n - d + 1 ) - d - {Q}^{′} ( d ) \\ = d \cdot ( {P}_{f}^{′} ( 2 \cdot n - d + 1 ) - 0.5 ) + ( {P}_{i} ( 2 \cdot n - d + 1 ) - 14 ) \\ d + 13.5 d - {Q}^{′} ( d ) ,\end{matrix} \qquad ( 32 c )$$

where P_{f}′(n) and Pᵢ′(n) are the fractional part and integer part of P′(n), i.e., P′(n)=Pᵢ′(n)+P_{f}′(n). Thus, in certain embodiments a suitably scaled/shifted P_{f}′(n), may be stored in memory, Similarly, in some exemplary embodiments, a suitably scaled/shifted value of Q′(d)+13.5d may be stored or a suitably scaled/shifted P_{f}′(n)−0.5 may be stored in memory. Thus, various combinations of parameters can be stored to facilitate faster computation of equation (32b).

Consider the decoder now. A main objective of defining F′(n, d) as in equation (29) is to decrease the complexity of the decoder. As mentioned before, the decoding process involves finding a largest value of pₖ such that F′(pₖ, k)≦Cₖ. The residual codeword Cₖ is the codeword left after part of the vector has been decoded and their contributions have been subtracted from the codeword C. An iterative method is used for finding such pₖ. To converge, this iterative method requires computation of F′(pₖ, k) for various values pₖ. Moreover, these iterations are performed several times for decoding of both the pulse magnitudes and the pulse positions. With the current modification to the definition of F′(n, d), the number of iteration required can be substantially reduced by computing the first guess of pₖ as:

$$\begin{matrix}{\hat{p}}_{k} = ⌊ \frac{1}{2} ( {exp}_{2} ( \frac{{log}_{2} ( {C}_{k} ) + k + {Q}^{′} ( k )}{k} ) + k - 1 ) ⌋ \\ = ⌊ ( {exp}_{2} ( \frac{{log}_{2} ( {C}_{k} ) + {Q}^{′} ( k )}{k} ) + \frac{k - 1}{2} ) ⌋\end{matrix} . \qquad ( 33 )$$

If n≦280, and m≦27, the value of pₖ is either \hat{p}ₖ or \hat{p}ₖ+1, whenever \hat{p}ₖ≧2·k. Thus, the combinatorial function may be computed only once to obtain pₖ. Note that Cₖ may be a multi-precision number (144-bits), hence computing the fractional part of the logarithm of Cₖ in equation (33) may be very complex. Hence, the fractional part of logarithm of Cₖ is calculated from the 9 most significant bits (MSBs) of Cₖ. The fractional part can be pre-stored. This fractional part is already stored as part of P′(n).

The reduction in complexity of the proposed arithmetic mean approximation of the combinatorial function is illustrated by incorporating this technique in the coding of modified discrete cosine transform (MDCT) of a embedded multi-layer speech/audio codec. The MDCT of the two last layers of the embedded code are coded using the proposed method. In each of the layer, n=280 MDCTs coefficients are coded using m=27 pulses. The coding of MDCTs is performed 2-times per 50 ms frame. These pulses are coded using modifications of the factorial packing method [1, 2, 3]. Each of these modifications use low complexity approximations of combinatorial function as described in [4]. In each of these approaches a mantissa and an exponent representation is used for the generation of codeword. The complexity reduction is also illustrated when the current invention is used in conjunction with the method of switching between coding of occupied and unoccupied position described in a recently filed patent disclosure. The complexities in WMOPs are shown in the Table.

| Using Arithmetic | Switching Coding of | |
|---|---|---|
| Mean | Occupied/Unoccupied | Complexity |
| Approximation | positions | (WMOPs) |
| NO | NO | 3.59 |
| YES | NO | 2.41 |
| NO | YES | 2.75 |
| YES | YES | 1.57 |

Note that the arithmetic mean approximation reduces the complexity by 1.0 WMOPS.

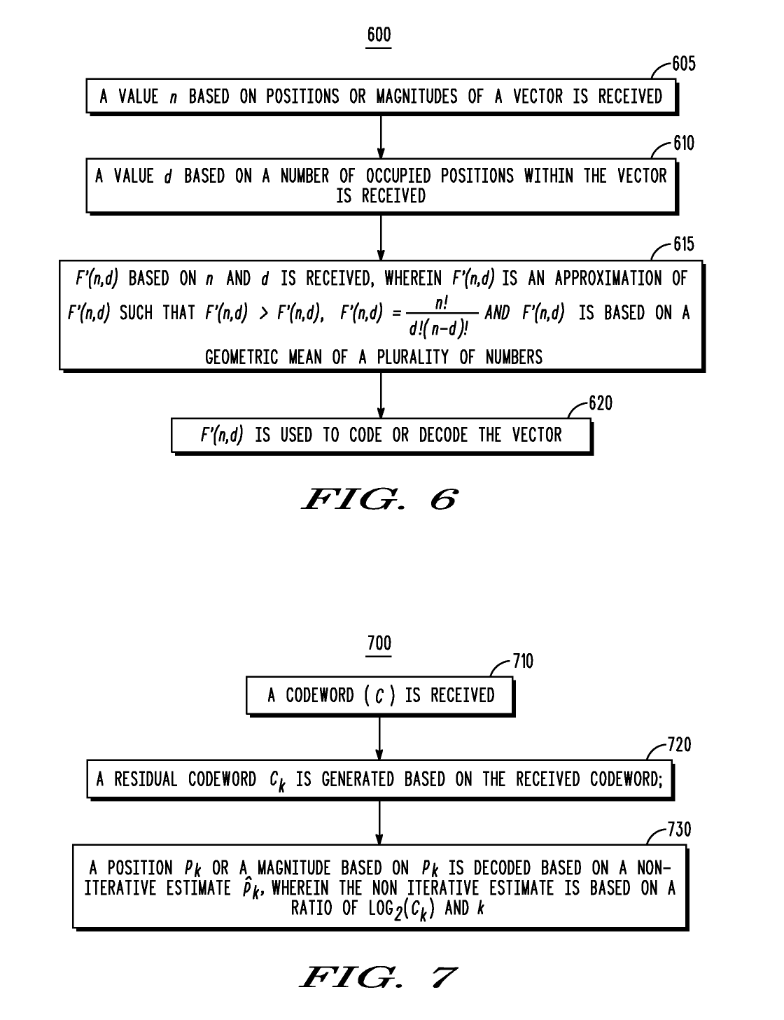

The above description may be further enhanced by reference to FIGS. 6 and 7. Referring now to FIG. 6, flow 600 illustrates a method for combinatorial encoding or decoding. At 605, a value n based on positions or magnitudes of a vector is received. At 610, a value d based on a number of occupied positions within the vector is received. F′(n, d) based on n and d is generated, wherein F′(n, d) is an approximation of F(n, d) such that F′(n, d)>F(n, d),

$$F ( n , d ) = \frac{n !}{d ! ( n - d ) !}$$

and F′(n, d) is based on an approximation of a geometric mean of a plurality of numbers, at 615. Next, at 620, F′(n, d) is used to code or decode the vector.

As previously discussed, an arithmetic mean may be used as the approximation of the geometric mean of the plurality of numbers. The plurality of numbers may be n n, n−1, n−2, n−d+1. The arithmetic mean may be given by

$$( n - \frac{d - 1}{2} )$$

and wherein

$${F}^{′} ( n , d ) = \frac{{( n - \frac{d - 1}{2} )}^{d}}{d !} .$$

Moreover, F′(n, d) may be based on an estimate of a logarithm of the approximation of the geometric mean of the plurality of numbers. The estimate of the logarithm of the approximation of the geometric mean may be based on P′(2n−d+1).

Generating F′(n, d) may further entail generating F′(n, d)=R′(d·P′(2·n−d+1)−d−Q′(d)), where P′(n)≈log₂(n),

$${Q}^{′} ( d ) \approx {\sum }_{i = 1}^{d} {log}_{2} ( i ) ,$$

R(k)≈2^{k}, and where k=d·P′(2·n−d+1)−d−Q′(d). This may be done such that F′(n, d)≧F(n, d) and F′(n, d)≧F′(n−1, d)+F′(n−1, d−1). At least a portion of P′(2n−d+1) may be fetched from a memory. And, k may be based on one or more terms stored in a memory. Further, as previously described, F′(n, d) may be based on the function: R′(k)=a^{k}^{ᵢ}^{-l}┌a^{l}K_{f}┐, where k=kᵢ+k_{f} is broken down into integer and fractional components of k, and K_{f}=a^{k}^{_{f}} is a Taylor series expansion of a fractional component of k. It may also be that l≦15.

Referring now to FIG. 7, flow 700 illustrates a method of decoding a vector from a codeword. As previously described, a codeword (C) is received at 710. At 720, a residual codeword Cₖ may be generated based on the received codeword. Next, a position pₖ or a magnitude derived from pₖ is decoded based on a non iterative estimate \hat{p}ₖ, wherein the non iterative estimate is based on a ratio of log₂(Cₖ) and k; this may be a ratio of log₂(Cₖ)+Q′(k) and k, as discussed. It is envisioned that the non iterative estimate \hat{p}ₖ is given by an expression

$$⌊ ( {exp}_{2} ( \frac{{log}_{2} ( {C}_{k} ) + {Q}^{′} ( k )}{k} ) + \frac{k - 1}{2} ) ⌋ .$$

Moreover, pₖ may be set equal to one of \hat{p}ₖ−1, \hat{p}ₖ, and \hat{p}ₖ+1. Also, the expression

$$⌊ ( {exp}_{2} ( \frac{{log}_{2} ( {C}_{k} ) + {Q}^{′} ( k )}{k} ) + \frac{k - 1}{2} ) ⌋$$

may be based on an approximation of log₂(Cₖ).

These descriptions of embodiments of the invention may be further understood by reference to the encoder and decoder apparatus; of FIGS. 1 and 2. The apparatus includes a combinatorial function generator that generates function F′(n, d) having properties F′(n, d)>F(n, d) and F′(n,d)≧F′(n−1,d)+F′(n−1,d−1), wherein F′(n, d) is used encode/decode a vector X_{cc} based on an approximation of a geometric mean of a plurality of numbers. Again, as previously described, an arithmetic mean may be used as the approximation of the geometric mean of the plurality of numbers, which may be n, n−1, n−2, n−d+1. The arithmetic mean may be given by

$$( n - \frac{d - 1}{2} )$$

and wherein

$${F}^{′} ( n , d ) = \frac{{( n - \frac{d - 1}{2} )}^{d}}{d !} .$$

It follows that F′(n, d) may be based on an estimate of a logarithm of the approximation of the geometric mean of the plurality of numbers, where the estimate of the logarithm of the approximation of the geometric mean is based on P′(2n−d+1). As previously described the function F′(n, d) generated by the combinatorial function generator may be given as: F′(n, d)=R′(d·P′(2·n−d+1)−d−Q′(d)), where P′(n)≈log₂(n),

$${Q}^{′} ( d ) \approx {\sum }_{i = 1}^{d} {log}_{2} ( i ) ,$$

R(k)≈2^{k}, and where k=d·P′(2·n−d+1)−d−Q′(d). Generating F′(n, d) encompasses generating F′(n, d) such that F′(n,d)≧F(n,d) and F′(n,d)≧F′(n−1,d)+F′(n−1,d−1).

The apparatus may further include a memory in communication with the combinatorial function generator. At least a portion of P′(2n−d+1) may be fetched from the memory, and k may be based on one or more terms stored in the memory.

The combinatorial function generator of the apparatus may be understood to be of an encoder or a decoder. A coder, such as encoder 100 of FIG. 1, for instance, is operable to receive F′(n, d) and vector X_{cc} and then generate a codeword based on the vector X_{cc} and F′(n, d). Conversely, a decoder is operable to receive a codeword and generate vector X_{cc} based on the codeword and F′(n, d).

With further reference to the decoder example, the decoder is operable to decode a position pₖ or magnitude derived from pₖ based on a non iterative estimate \hat{p}ₖ, wherein the non iterative estimate is based on a ratio of log₂(Cₖ) and k, such as log₂(Cₖ)+Q′(k) and k as an example. In this case, the non iterative estimate \hat{p}ₖ is given by an expression

$$⌊ ( {exp}_{2} ( \frac{{log}_{2} ( {C}_{k} ) + {Q}^{′} ( k )}{k} ) + \frac{k - 1}{2} ) ⌋ .$$

pₖ is equal to one of values \hat{p}ₖ−1, \hat{p}ₖ, and \hat{p}ₖ+1. As described, the expression

$$⌊ ( {exp}_{2} ( \frac{{log}_{2} ( {C}_{k} ) + {Q}^{′} ( k )}{k} ) + \frac{k - 1}{2} ) ⌋$$

may be based on an approximation of log₂(Cₖ). Referring back to the earlier Taylor series discussion, F′(n, d) may be based on the function:

R′(k)=a^{k}^{ᵢ}^{-l}┌a^{l}K_{f}┐,

where k=kᵢ+k_{f} is broken down into integer and fractional components of k, and K_{f}=a^{k}^{_{f}} is a Taylor series expansion of a fractional component of k; it may occur that l≦15.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for combinatorial encoding or decoding, the method comprising:
receiving a value n based on positions or magnitudes of a vector;
receiving a value d based on a number of occupied positions within the vector;
generating F′(n, d) based on n and d, wherein F′(n, d) is an approximation of F(n, d) such that F′(n, d)>F(n, d) and wherein
$$F ( n , d ) = \frac{n !}{d ! ( n - d ) !}$$
and wherein F′(n, d) is based on an approximation of a geometric mean of a plurality of numbers and
using F′(n, d) to code or decode the vector.

2. A method of claim 1, wherein an arithmetic mean is used as the approximation of the geometric mean of the plurality of numbers.

3. A method of claim 2, wherein the plurality of numbers comprises of n, n−1, n−2, n−d+1, the arithmetic mean is given by
$$( n - \frac{d - 1}{2} )$$
and
$${F}^{′} ( n , d ) = \frac{{( n - \frac{d - 1}{2} )}^{d}}{d !} .$$

4. A method of claim 1, wherein F′(n, d) is based on an estimate of a logarithm of the approximation of the geometric mean of the plurality of numbers.

5. A method of claim 4, wherein the estimate of the logarithm of the approximation of the geometric mean is based on P′(2·n−d+1).

6. The method of claim 1, wherein generating F′(n, d) further comprises generating
$${F}^{′} ( n , d ) = {R}^{′} ( d \cdot {P}^{′} ( 2 \cdot n - d + 1 ) - d - {Q}^{′} ( d ) ) , \\ where$$
$${P}^{′} ( n ) \approx {log}_{2} ( n ) , \\ {Q}^{′} ( d ) \approx {\sum }_{i = 1}^{d} {log}_{2} ( i ) , \\ R ( k ) \approx {2}^{k} , \\ and$$
$$k = d \cdot {P}^{′} ( 2 \cdot n - d + 1 ) - d - {Q}^{′} ( d ) .$$

7. The method of claim 6, wherein generating F′(n, d) comprises generating F′(n, d) such that F′(n, d)≧F(n, d) and F′(n, d)≧F′(n−1, d)+F′(n−1, d−1).

8. A method of decoding a vector from a codeword comprising:
receiving a codeword (C);
generating a residual codeword Cₖ based on the received codeword;
decoding a position pₖ or a magnitude derived from pₖ based on a non iterative estimate \hat{p}ₖ, wherein the non iterative estimate is based on a ratio of log₂(Cₖ) and k.

9. The method of claim 8, wherein the non iterative estimate \hat{p}ₖ is given by an expression
$$⌊ ( {exp}_{2} ( \frac{{log}_{2} ( {C}_{k} ) + {Q}^{′} ( k )}{k} ) + \frac{k - 1}{2} ) ⌋ .$$

10. A method of claim 8, further comprising:
setting pₖ equal to one of \hat{p}ₖ−1, \hat{p}ₖ, and \hat{p}ₖ+1.

11. A method of claim 8, wherein the expression
$$⌊ ( {exp}_{2} ( \frac{{log}_{2} ( {C}_{k} ) + {Q}^{′} ( k )}{k} ) + \frac{k - 1}{2} ) ⌋$$
is based on an approximation of log₂(Cₖ).

12. An apparatus comprising:
a combinatorial function generator that generates function F′(n, d) having properties F′(n, d)>F(n, d) and F′(n,d)≧F′(n−1,d)+F′(n−1,d−1), wherein F′(n, d) is used encode/decode a vector X_{cc} based on an approximation of a geometric mean of a plurality of numbers.

13. The apparatus of claim 12, wherein an arithmetic mean is used as the approximation of the geometric mean of the plurality of numbers.

14. The apparatus of claim 13, wherein the plurality of numbers comprises n, n−1, n−2, n−d+1, the arithmetic mean is given by
$$( n - \frac{d - 1}{2} )$$
and
$${F}^{′} ( n , d ) = \frac{{( n - \frac{d - 1}{2} )}^{d}}{d !} .$$

15. The apparatus of claim 12, wherein F′(n, d) is based on an estimate of a logarithm of the approximation of the geometric mean of the plurality of numbers.

16. The apparatus of claim 15, wherein the estimate of the logarithm of the approximation of the geometric mean is based on P′(2·n−d+1).

17. The apparatus of claim 12, wherein function F′(n, d) is given as:
$${F}^{′} ( n , d ) = {R}^{′} ( d \cdot {P}^{′} ( 2 \cdot n - d + 1 ) - d - {Q}^{′} ( d ) ) , \\ where$$
$${P}^{′} ( n ) \approx {log}_{2} ( n ) , \\ {Q}^{′} ( d ) \approx {\sum }_{i = 1}^{d} {log}_{2} ( i ) , \\ R ( k ) \approx {2}^{k} , \\ and where$$
$$k = d \cdot {P}^{′} ( 2 \cdot n - d + 1 ) - d - {Q}^{′} ( d ) .$$

18. The apparatus of claim 17, further comprising a memory, wherein at least a portion of P′(2n−d+1) is fetched from the memory.

19. The apparatus of claim 17, further comprising a memory, wherein k is based on one or more terms stored in the memory.

20. The apparatus of claim 12, further comprising:
a coder that receives F′(n, d) and vector X_{cc} and generates a codeword based on the vector X_{cc} and F′(n, d).

21. The apparatus of claim 12, further comprising:
a decoder that receives a codeword and generates vector X_{cc} based on the codeword and F′(n, d).

22. The apparatus of claim 21, wherein the decoder decodes a position pₖ or a magnitude based on pₖ based on a non iterative estimate \hat{p}ₖ wherein the non iterative estimate is based on a ratio of log₂(Cₖ) and k.

23. The apparatus of claim 22, wherein the non iterative estimate \hat{p}ₖ is given by an expression
$$⌊ ( {exp}_{2} ( \frac{{log}_{2} ( {C}_{k} ) + {Q}^{′} ( k )}{k} ) + \frac{k - 1}{2} ) ⌋ .$$

24. The apparatus of claim 22, wherein pₖ is one of \hat{p}ₖ−1, \hat{p}ₖ, and \hat{p}ₖ+1.

25. The apparatus of claim 22, wherein the expression
$$⌊ ( {exp}_{2} ( \frac{{log}_{2} ( {C}_{k} ) + {Q}^{′} ( k )}{k} ) + \frac{k - 1}{2} ) ⌋$$
is based on an approximation of log₂(Cₖ).
